(19) United States
(12) Patent Application Publication
(10) Pub. No.: US 2016/0198690 A1
(43) Pub. Date: Jul. 14, 2016

(54) Fishing Line Container

(71) Applicant: Academy, Ltd., Katy, TX (US)

(72) Inventors: Christopher M. Williford, Katy, TX (US); Dennis Krieger, Katy, TX (US)

(21) Appl. No.: 14/592,839

(22) Filed: Jan. 8, 2015

(51) Int. Cl. A01K 97/06; A01K 91/00

(52) U.S. Cl. CPC A01K 97/06; A01K 91/00

(57) ABSTRACT

Disclosed is a fishing line container that may include, in some instances, a first container portion and a second container portion movable between an open configuration and a closed configuration, a first fishing rod opening in the fishing line container, wherein the first container portion has a first portion of the first fishing rod opening and the second container portion has a second portion. The first container portion may include a first portion of the second fishing rod opening and the second container portion may includes a second portion of the second fishing rod opening. The first and second fishing rod openings may be aligned such that a portion of a fishing rod can extend through the fishing line container. A first fishing line opening in the fishing line container may be configured to allow fishing line to be drawn from the fishing line container.

### FIELD

Devices and methods for spooling fishing line including loading new fishing line onto a fishing reel.

### BACKGROUND

Anglers often need to replace or install fishing line on their fishing reel. Existing devices and methods for installing fishing line often fail when attempting to efficiently and effectively install fishing line. There is a need for improved devices and methods for installing fishing line.

### SUMMARY

Disclosed is a fishing line container that facilitates installation of the spooled line in the container onto a reel. The fishing line container is configured to temporarily attach to a fishing rod during installation of the line such that the line may be efficiently and effectively drawn from the container and wound onto the reel of the fishing rod.

### BRIEF DESCRIPTION OF THE DRAWINGS

Illustrative, but non-limiting, embodiments of the present invention are described in detail below with reference to the following drawing figures.

FIG. 1 is a perspective view of the fishing line container, shown in a closed configuration.

FIGS. 2A and 2B are side and front views of the fishing line container depicted in FIG. 1.

FIGS. 3A and 3B are views of the fishing line container of FIG. 1 in the open configuration.

FIG. 4 is a partial perspective view of the fishing line container of FIG. 1 in the open configuration.

FIGS. 5A and 5B are front and side views of the fishing line container of FIG. 1 in the open configuration.

FIGS. 6A and 6B are views of a fishing line container installed on a fishing rod.

FIG. 7 is a perspective view of a fishing line container, shown in a closed configuration.

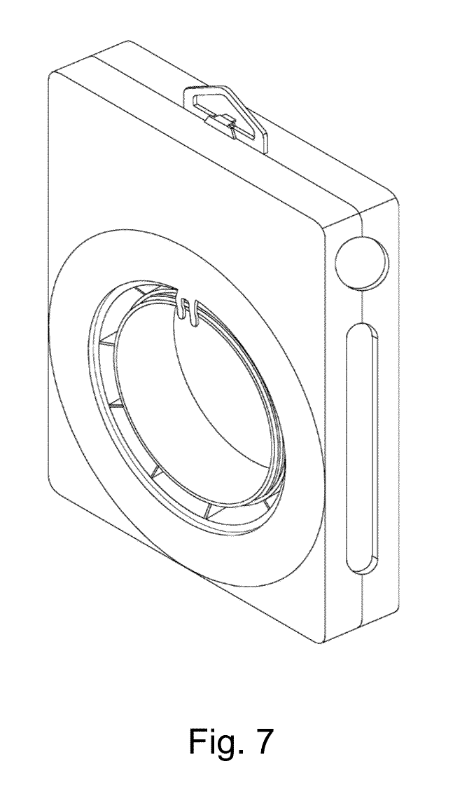

FIG. 8 is a front view of the fishing line container of FIG. 7, shown in the closed configuration.

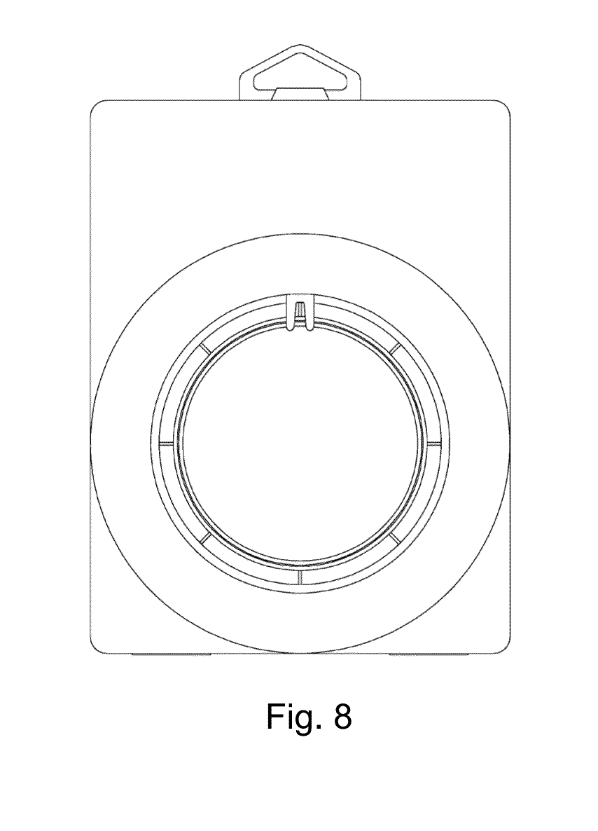

FIG. 9 is a rear view of the fishing line container of FIG. 7, shown in the closed configuration.

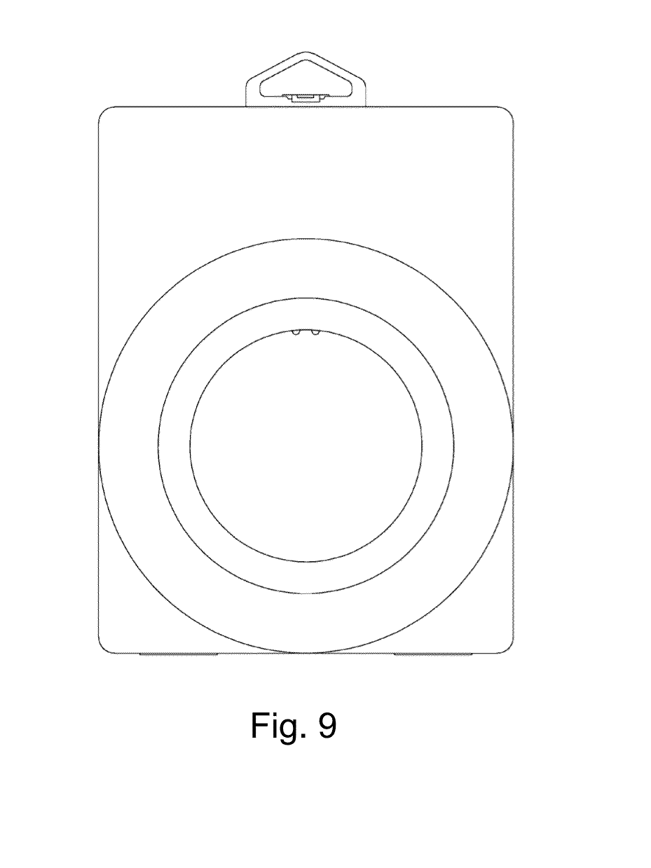

FIG. 10 is a side view of the fishing line container of FIG. 7, shown in the closed configuration.

FIGS. 11A, 11B, and 11C are side views of the fishing line container of FIG. 7, shown in the closed configuration.

FIGS. 12A and 12B are side and top views of the fishing line container of FIG. 7, shown in the open configuration.

### DETAILED DESCRIPTION

This section describes non-limiting examples of devices and methods for spooling fishing line including loading new fishing line onto a fishing reel, and does not limit the scope of the inventions claimed. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

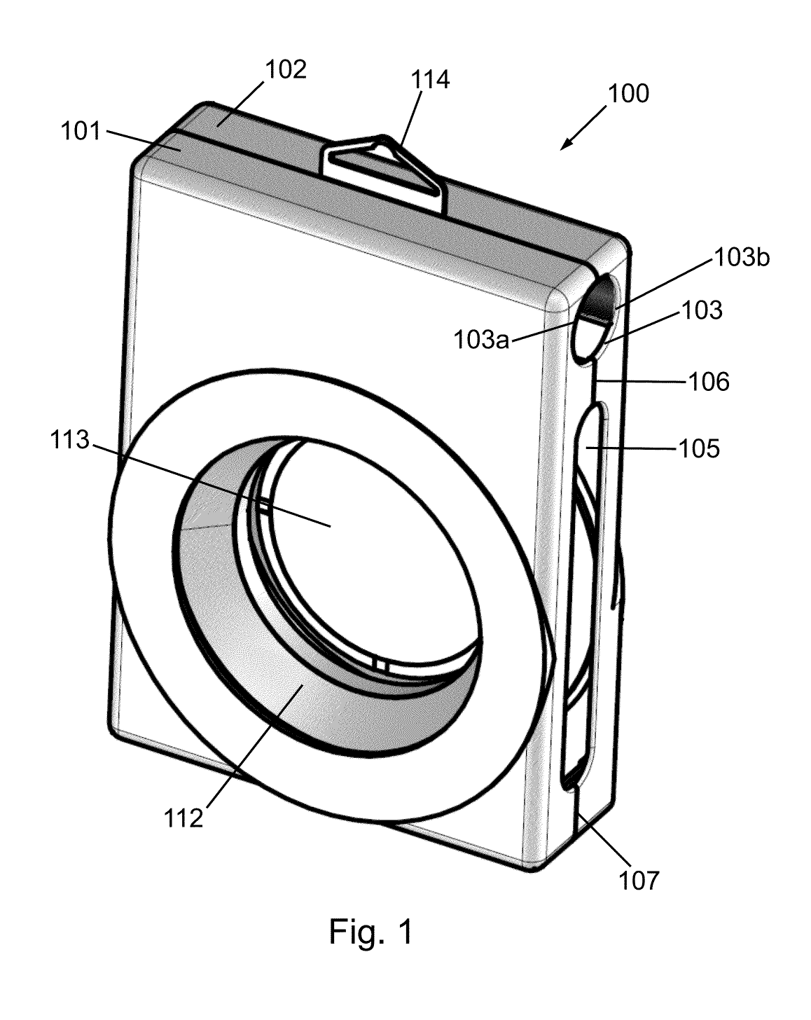

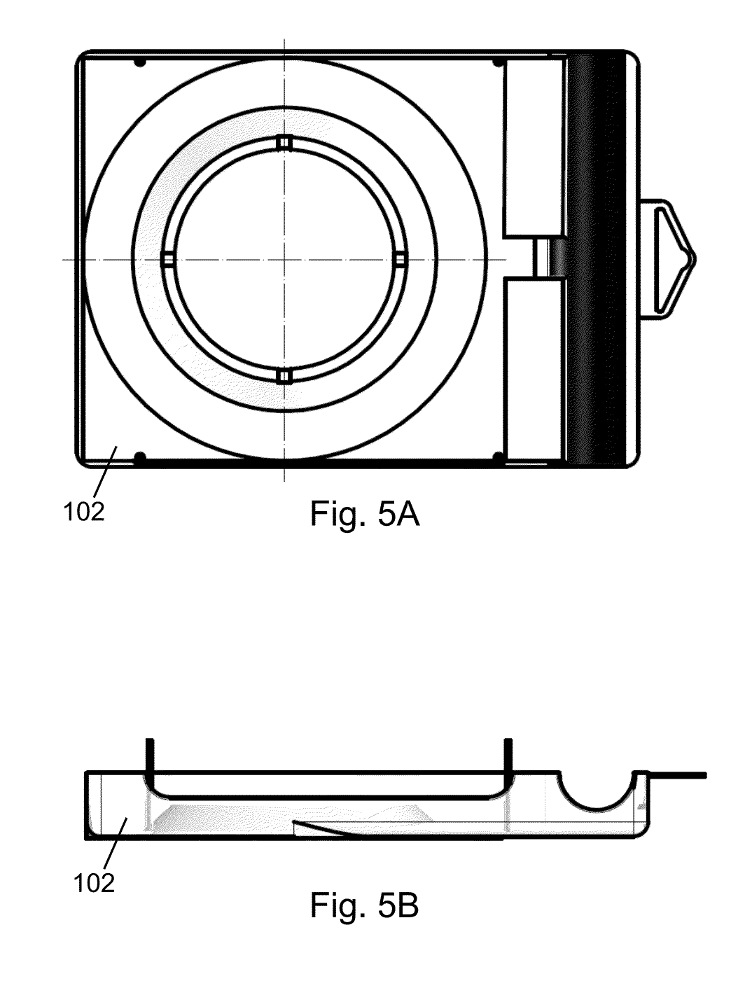

FIGS. 1-5B illustrate an exemplary embodiment of a fishing line container 100 that facilitates installation of fishing line onto a fishing reel without requiring removal of the fishing line spool 202 from the fishing line container 100. As described in more detail below, the fishing line container 100 can be attached to a fishing rod 201 using first fishing rod opening 103 and second fishing rod opening 104 such that fishing line can be drawn through first fishing line opening 105 from the fishing line container 100 onto a reel mounted on the fishing rod 201.

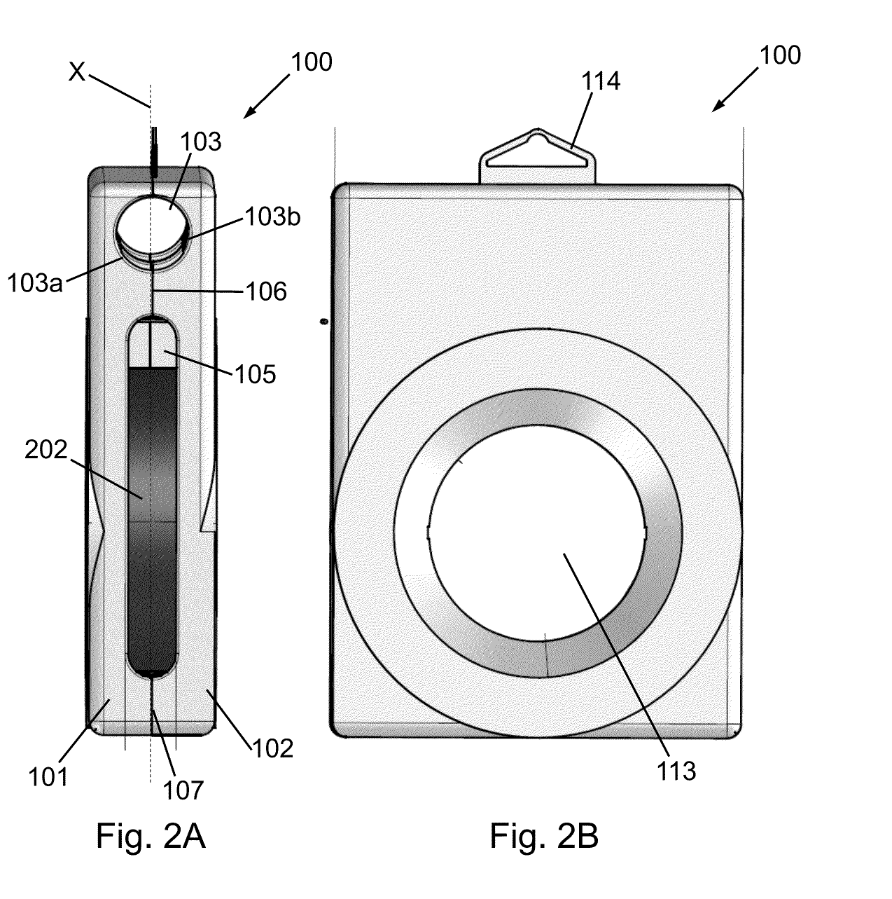

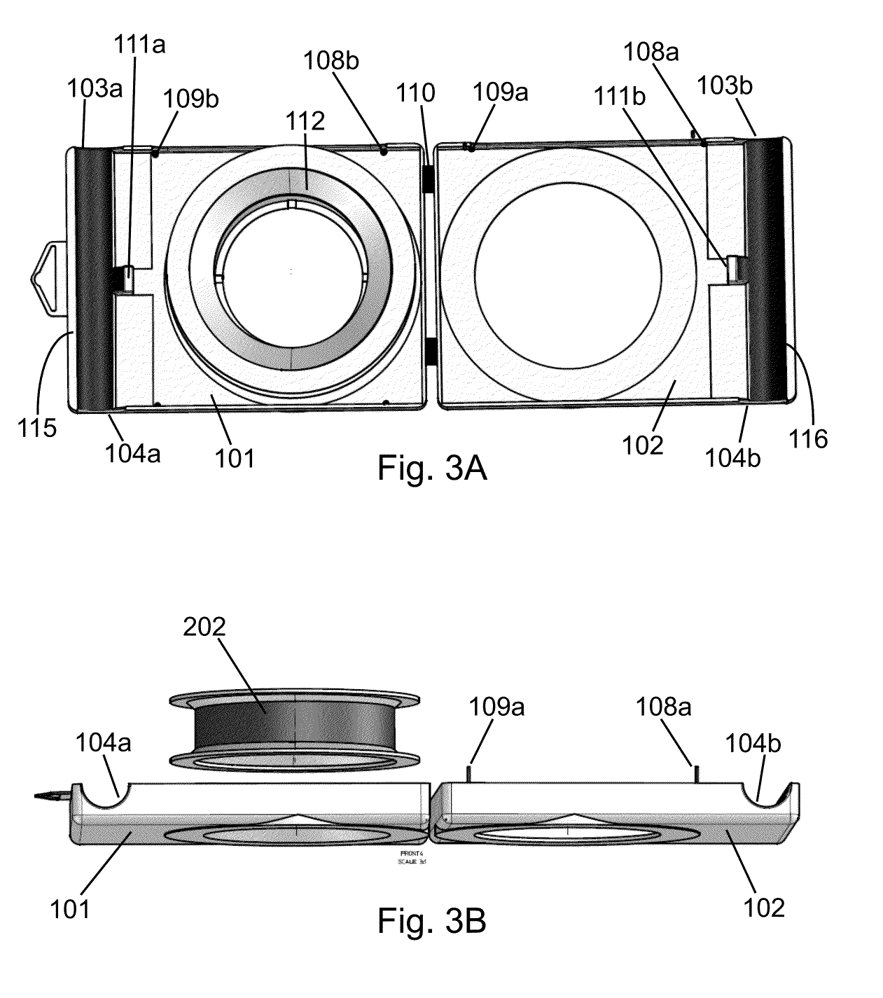

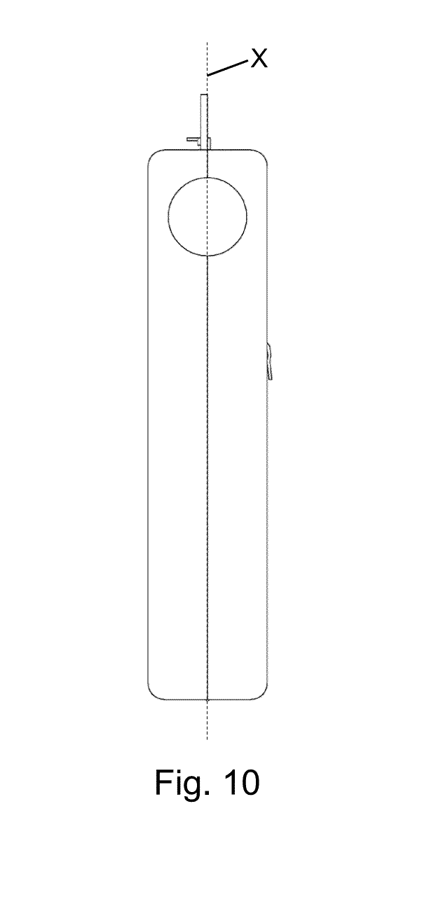

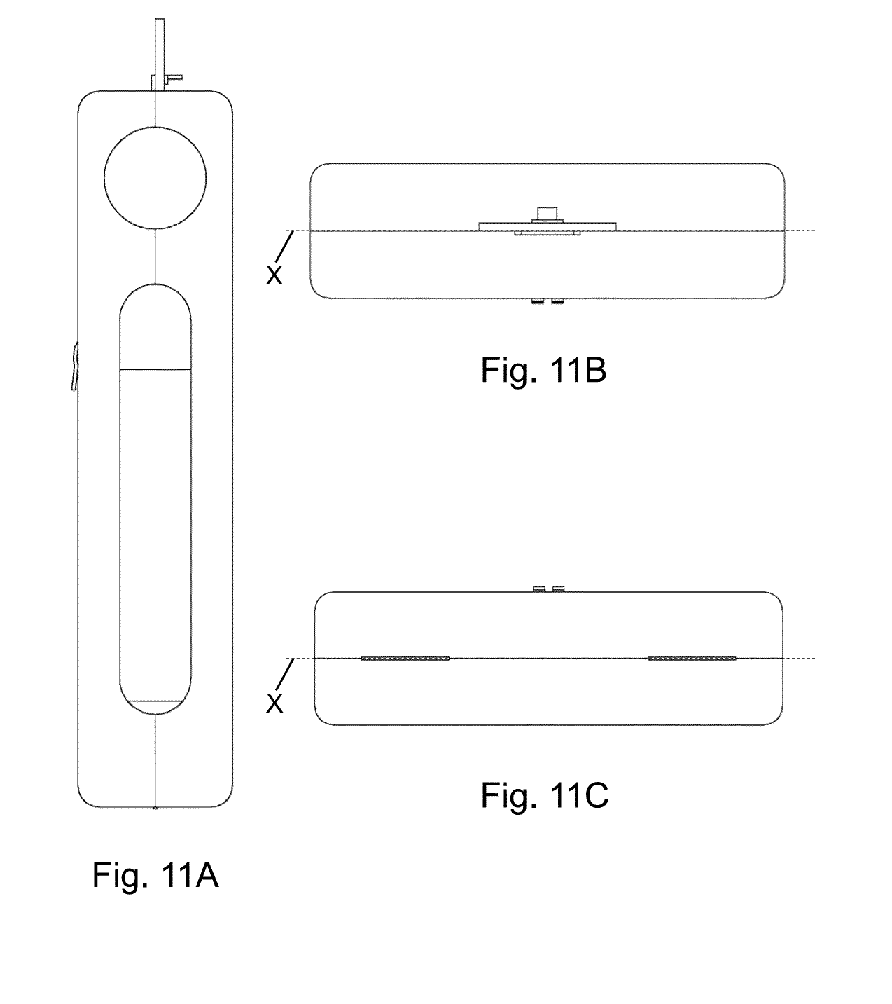

As illustrated in FIGS. 1-3B, the fishing line container 100 includes a first container portion 101 and a second container portion 102 that can be moved between an open configuration and a closed configuration. The closed configuration is shown in FIGS. 1-2B and the open configuration is shown in FIGS. 3A and 3B. The first container portion 101 and the second container portion 102 may be completely separable from one another or may be connected by one or more hinges 110 (a hinged embodiment is shown in FIG. 3A) where the fishing line container 100 may function as a clamshell device. The first container portion 101 and the second container portion 102 are illustrated as approximately equal in size with an interface at interfacing plane X (see FIGS. 2A, 10, 11B, and 11C). However, in some embodiments, the first container portion 101 and the second container portion 102 may be unequal in size such that interfacing surface X is not approximately halfway through the thickness of fishing line container 100. Furthermore, interfacing surface X is illustrated as planar; however, in some embodiments, interfacing surface X may include surfaces in multiple planes and/or one or more curved non-planar surfaces.

To secure the fishing line container 100 to a fishing rod 201, the fishing line container 100 may include one more fishing rod openings. For example, in some embodiments, the fishing line container 100 may include a first fishing rod opening 103 where the first container portion 101 includes a first portion 103a of the first fishing rod opening 103 and the second container portion 102 includes a second portion 103b of the first fishing rod opening 103. Similarly, there may be a second fishing rod opening 104 in the fishing line container 100 where the first container portion 101 includes a first portion 104a of the second fishing rod opening 104 and the second container portion 102 includes a second portion 104b of the second fishing rod opening 104.

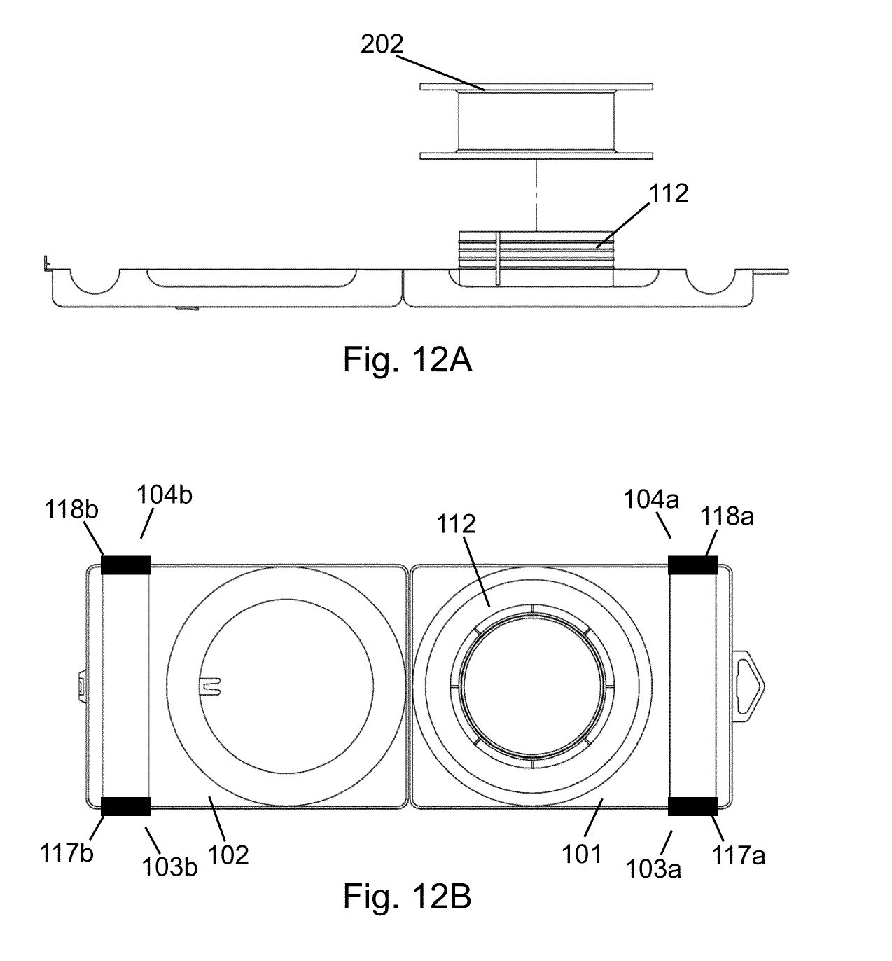

In some embodiments, the first fishing rod opening 103 and the second fishing rod opening 104 may include additional features to secure the fishing line container 100 with respect to the fishing rod 201. For example, as shown in FIG. 3A, the fishing line container 100 may include gasket or grommet that extends the full length between first fishing rod opening 103 and second fishing rod opening 104. The gasket or grommet may include a first portion 115 attached to the first container portion 101 and a second portion 116 attached to the second container portion 102. In some embodiments, the first portion 115 and the second portion 116 each have a channel shape with an approximate semi-circular cross-section (see FIG. 3A). In some embodiments, the first fishing rod opening 103 and the second fishing rod opening 104 each may have a pair of grommets disposed adjacent to the outer surface of the fishing line container 100. For example, as shown in FIG. 12B, the first fishing rod opening 103 may have a two-piece grommet that includes first grommet portion 117a (attached to first container portion 101) and second grommet portion 117b (attached to second container portion 102). Similarly, the second fishing rod opening 104 may also have a two-piece grommet that includes first grommet portion 118a (attached to first container portion 101) and second grommet portion 118b (attached to second container portion 102).

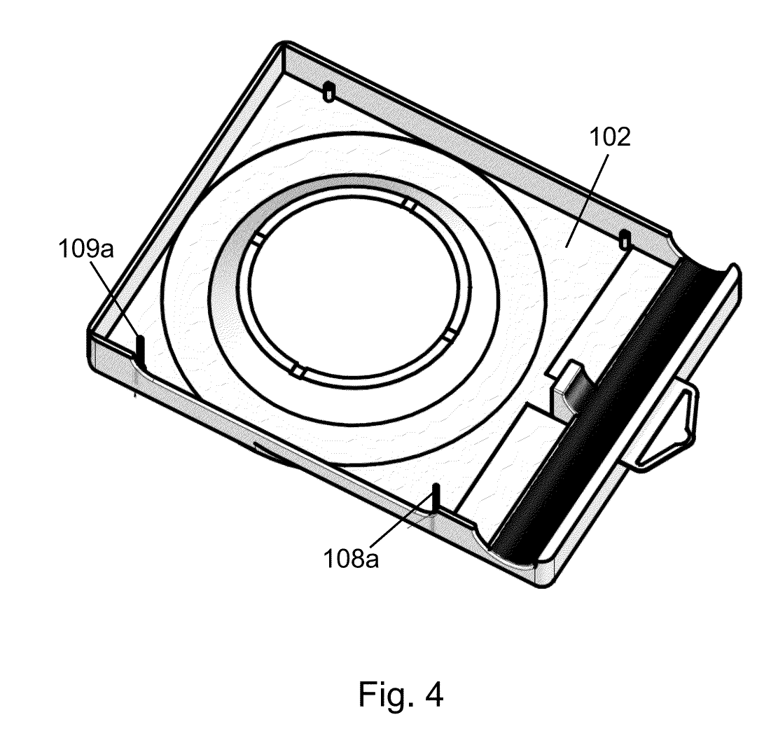

The fishing line container 100 may include a first junction 106 between the first container portion 101 and the second container portion 102 adjacent the first fishing line opening 105 when in the closed configuration. In addition, in some embodiments, the fishing line container 100 may include a first member 108a extending across the first junction 106 proximate the first fishing line opening 105. As shown in FIGS. 3B and 4, in some embodiments, first member 108a may be a pin 108a. Pin 108a may be permanently attached to the second container portion 102. The free end of pin 108a may interface with a matching receptacle 108b disposed in the first container portion 101. In addition to the first member 108a disposed adjacent to the first junction 106, the fishing line container 100 may include a second junction 107 between the first container portion 101 and the second container portion 102 adjacent an opposite end of the first fishing line opening 105 (with respect to first junction 106) when in the closed configuration. Adjacent to the second junction 107, some embodiments may include a second member 109a extending across the second junction 107 proximate the first fishing line opening 105. The free end of pin 109a may interface with a matching receptacle 109b disposed in the first container portion 101.

The members 108a and 109a provide multiple benefits. For example, the members 108a and 109a (which may be pins) act to locate the second container portion 102 with respect to the first container portion 101, which facilitates assembly and reduces possible misalignment issues when assembling the fishing line container 100. In addition, the location of the members 108a and 109a adjacent to the respective ends of the first fishing line opening 105 allows the pins to act as boundaries for the fishing line that is fed through first fishing line opening 105. As the fishing line is pulled from spool 202, the pins (acting as boundaries) prevent the fishing line from impinging on or entering into first junction 106 and second junction 107. Without the members 108a and 109a, the fishing line could be wedged into first junction 106 and/or second junction 107, which could create problems related to fraying/weakening the line or adding significant friction to the feeding process if not jamming it entirely.

As shown in FIGS. 1, 3A, and 12A, the fishing line container 100 may include a protrusion 112 extending from an interior surface of the first container portion 101 such that a spool 202 of fishing line rotates about the protrusion 112. In some embodiments, the protrusion 112 may include a concentric through-hole 113 that extends through the fishing line container 100.

To provide convenience for storing the fishing line container 100 (either in a consumer marketing setting or in a home-user setting), the fishing line container 100 may include a hanger 114.

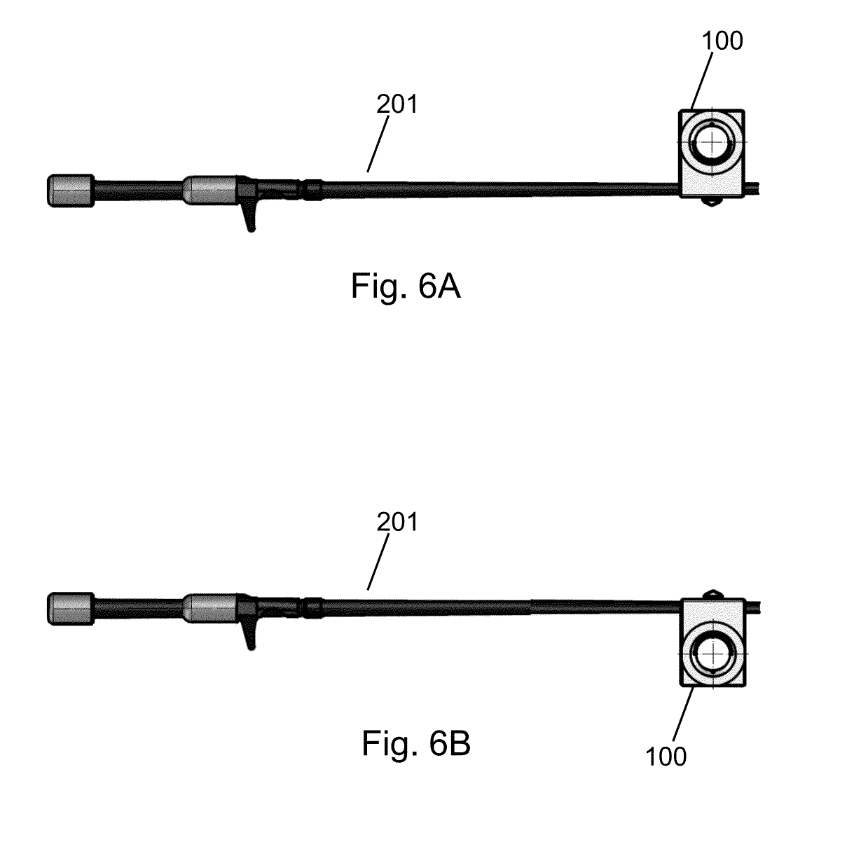

As shown in FIGS. 6A and 6B, the fishing line container 100 may be configured to function with various types of fishing equipment. For example, reels that mount on a top side of a fishing rod (such as a bait-casting reel) are compatible with the fishing line container 100, which can be mounted on the top side of a fishing rod (see FIG. 6A). In addition, reels that mount on a bottom side of a fishing rod (such as a spin-casting reel) are compatible with the fishing line container 100, which can be mounted on the bottom side of a fishing rod (see FIG. 6B).

The fishing line container 100 may be formed of any suitable material including, but not limited to, rigid plastic, soft plastic, aluminum, steel, aramid fibers, other metallic or sheet metal materials, other plastic materials, composite materials, or other similar materials.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A fishing line container comprising:
a first container portion and a second container portion movable between an open configuration and a closed configuration;
a first fishing rod opening in the fishing line container, wherein the first container portion comprises a first portion of the first fishing rod opening and the second container portion comprises a second portion of the first fishing rod opening;
a second fishing rod opening in the fishing line container, wherein the first container portion comprises a first portion of the second fishing rod opening and the second container portion comprises a second portion of the second fishing rod opening;
wherein the first and second fishing rod openings are aligned such that a portion of a fishing rod can extend through the fishing line container; and
a first fishing line opening in the fishing line container configured to allow fishing line to be drawn from the fishing line container.

2. The fishing line container of claim 1, wherein the fishing line container further comprises a first junction between the first container portion and the second container portion adjacent the first fishing line opening when in the closed configuration; and a member extending across the first junction proximate the first fishing line opening.

3. The fishing line container of claim 2, wherein the member is configured to prevent fishing line from entering the first junction.

4. The fishing line container of claim 2, wherein at least a portion of the member extends across at least a portion of the first fishing line opening.

5. The fishing line container of claim 4, wherein the member comprises a pin extending between the first container portion and the second container portion when in the closed configuration.

6. The fishing line container of claim 2, wherein the fishing line container further comprises a second junction between the first container portion and the second container portion adjacent an opposite end of the first fishing line opening when in the closed configuration; and a second member extending across the second junction proximate the opposite end of the first fishing line opening.

7. The fishing line container of claim 1, wherein the fishing line container is a clamshell container such that the first container portion and the second container portion are attached with a hinge.

8. The fishing line container of claim 1, wherein the fishing line container further comprises a latch configured to lock the fishing line container in the closed configuration.

9. The fishing line container of claim 1, wherein the fishing line container further comprises a protrusion extending from an interior surface of the first container portion such that a spool of fishing line rotates about the protrusion.

10. The fishing line container of claim 1, wherein the fishing line container further comprises a first gasket disposed adjacent to the first container portion and a second gasket disposed adjacent to the second container portion wherein the first gasket and the second gasket are configured to surround the fishing rod.

11. A method of using a fishing line container, the method comprising:
providing a fishing line container comprising:
a first container portion and a second container portion movable between an open configuration and a closed configuration, a first fishing rod opening in the fishing line container;
wherein the first container portion comprises a first portion of the first fishing rod opening and the second container portion comprises a second portion of the first fishing rod opening;
a second fishing rod opening in the fishing line container, wherein the first container portion comprises a first portion of the second fishing rod opening and the second container portion comprises a second portion of the second fishing rod opening;
wherein the first and second fishing rod openings are aligned such that a portion of a fishing rod can extend through the fishing line container; and
a first fishing line opening in the fishing line container configured to allow fishing line to be drawn from the fishing line container;
opening the fishing line container into the open configuration;
inserting the fishing rod into the first and second fishing rod openings when the fishing line container is in the open configuration;
closing the fishing line container into the closed configuration; and
feeding fishing line through the first fishing line opening.

12. The method of claim 11, further comprising aligning a member disposed on the second container portion with a corresponding receptacle on the first container portion where the member extends across a first junction proximate the first fishing line opening.

13. The method of claim 12, further comprising inserting the member into the corresponding receptacle.

14. The method of claim 11, further comprising inserting a spool of fishing line onto a protrusion when the fishing line container is in the open configuration wherein the protrusion extend from an interior surface of the first container portion.
